(19) United States
(12) Patent Application Publication
(10) Pub. No.: US 2008/0130496 A1
(43) Pub. Date: Jun. 5, 2008

(54) METHOD AND SYSTEM FOR VIDEO TRANSMISSION USING 3G MOBILE NETWORK

(75) Inventors: Wen-Yi Kuo, TAIPEI (TW); Ruei-Ming Yu, SINDIAN CITY (TW); Li-Chung Chuang, SINDIAN CITY (TW); Chang-Han Wu, SINDIAN CITY (TW)

Correspondence Address: PAI PATENT & TRADEMARK LAW FIRM, 1001 FOURTH AVENUE, SUITE 3200, SEATTLE, WA, 98154, US

(73) Assignee: BANDRICH INC., SINDIAN CITY (TW)

(21) Appl. No.: 11/755,739

(22) Filed: May 31, 2007

Related U.S. Application Data
(60) Provisional application No. 60/868,218, filed on Dec. 1, 2006.

(51) Int. Cl. G08C 15/00

(52) U.S. Cl. 370/230.1

(57) ABSTRACT

A system for video transmission using 3G mobile network includes a mobile video transmitter and a server. The mobile video transmitter is capable of transmitting a plurality of video packets via a plurality of uplink channels of the 3G mobile network. The mobile video transmitter includes a data splitter that is capable of splitting the video packets; a plurality of transmitting devices coupled to the data splitter, each of the transmitting devices having a transceiver. The data splitter assigns the video packets to the transmitting devices using a water filling method such that the video packets waiting for lo transmission in each of the transmitting devices are equal. The server receiving the video packets via the 3G mobile network is capable of sequencing and combining the video packets into a video signal. A method using the foregoing system for video transmission using 3G mobile network is also provided.

### CROSS-REFERENCE TO RELATED APPLICATION

This application claims the priority benefit of U.S. Provisional Application Ser. No. 60/868,218, filed Dec. 1, 2006, the full disclosures of which are incorporated herein by reference.

### BACKGROUND

1. Field of Invention

The present invention relates to a video signal transmission. More particularly, the present invention relates to method and system for a higher resolution mobile video transmission using 3G mobile network.

2. Description of Related Art

Conventionally, in the live transmission of a scene of events to a center the time required for delivery of video materials is urgent, for example, high resolution news material (data) for a broadcast television station. Because urgency is required, video materials photographed or images picked up at the photographing field site are transmitted either directly or after undergoing editing, through channels of SNG (Satellite News Gathering). By employing such a satellite transmission system, a huge truck with a big satellite antenna and the rental of expensive satellite channels are necessary. For police and fire fighters, a special mobile radio (SMR) with proprietary and expensive equipment has been used to report back the live scene of events to a controlling center.

New digital cellular mobile systems, for example, 3G mobile networks using technologies such as Wideband Code Division Multiple Access (WCDMA), or Universal Mobile Telecommunications System (UMTS) have the advantage of higher data rate transmission, and it does not matter where the source equipment is located in the world. However, the higher data transmission rate of 2 megabits per second is usually applied only to the downlink. In the uplink circuit-switched services, most commercial 3G WCDMA/UMTS mobile networks support one 64 Kbps channel per mobile user, wherein one mobile user refers to the normal usage of one transceiver (with one SIM). For uplink lo packet-switched services, some commercial 3G WCDMA/UMTS mobile networks support up to one 364 kbps channel for one mobile user but many systems only support up to one 256 kbps channel for one mobile user or even 128 Kbps channel for one mobile user.

For the forgoing reasons, there is a need for method and system that can be used to transmit higher bandwidth in the uplink to allow for delivery of video materials back to a center in a quick and efficient way.

### SUMMARY

According to one embodiment, a system for video transmission using 3G mobile network includes a mobile video transmitter and a server. The mobile video transmitter is capable of transmitting a plurality of video packets via a plurality of uplink channels of 3G mobile network. The mobile video transmitter includes a data splitter that is capable of splitting the video packets; a plurality of transmitting devices coupled to the data splitter, each of the transmitting devices having a transceiver, and the transmitting devices are capable of processing and transmitting the video packets. The data splitter assigns the video packets to the transmitting devices using a water filling method such that the number of video packets waiting for transmission in each of the transmitting devices is equal. The server receiving the video packets via the 3G mobile network is capable of sequencing and combining the video packets into the original video signal.

According to one embodiment, a system for video transmission using 3G mobile network includes a mobile video transmitter and a server. The mobile video transmitter is capable of transmitting a plurality of video packets via a lo plurality of uplink channels of the 3G mobile network and includes a video encoder, which is capable of converting a video signal into the video packets; a plurality of transmitting devices, each of the transmitting devices having a transceiver and a baseband processor, where one of the baseband processors is connected to the video encoder, the baseband processors are capable of processing and splitting the video packets, and the transceivers are capable of transmitting the video packets. The baseband processors are connected in series to process a portion of the video packets for transmission, and the video encoder is capable of converting the video signal into the video packets based on amount of video packets waiting for transmission in the transceivers or the error rate of the video packets. The server receiving the video packets via the 3G mobile network is capable of sequencing and combining the video packets into the original video signal.

According to one embodiment, the method for video transmission using 3G mobile network includes encoding a video signal into a plurality of video packets; assigning the video packets to a plurality of transmitting devices of a mobile video transmitter; transmitting the video packets using a plurality of transceivers of the mobile video transmitter via a plurality of uplink channels of the 3G mobile network; and receiving the video packets by a server, the server sequencing and combining the video packets into the original video signal.

It is to be understood that both the foregoing general description and the following detailed description are by examples, and are intended to provide further explanation of the invention as claimed.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention. In the drawings,

FIG. 1 is a diagram illustrating a system for video transmission using 3G mobile network according to one embodiment of this invention;

FIG. 2 is a diagram illustrating a system for video transmission using 3G mobile network according to another embodiment of this invention;

FIG. 3 is a diagram illustrating a mobile video transmitter having 4 transceivers according to one embodiment of this invention;

FIG. 4 is a diagram illustrating a mobile video transmitter having 4 transceivers and using 3 frequencies according to another embodiment of this invention;

FIG. 5 is a diagram illustrating a mobile video transmitter using 2 mobile operators and having 2 frequencies according to another embodiment of this invention;

FIG. 6 is a diagram illustrating a mobile video transmitter using 2 mobile operators and having 4 frequencies according to another embodiment of this invention; and

FIG. 7 is a flowchart illustrating a method for video transmission using 3G mobile network according to one embodiment of this invention.

### DESCRIPTION OF THE PREFERRED EMBODIMENTS

Reference will now be made in detail to the present preferred embodiments of the invention, examples of which are illustrated in the accompanying drawings. Wherever possible, the same reference numbers are used in the drawings and the description to refer to the same or like parts.

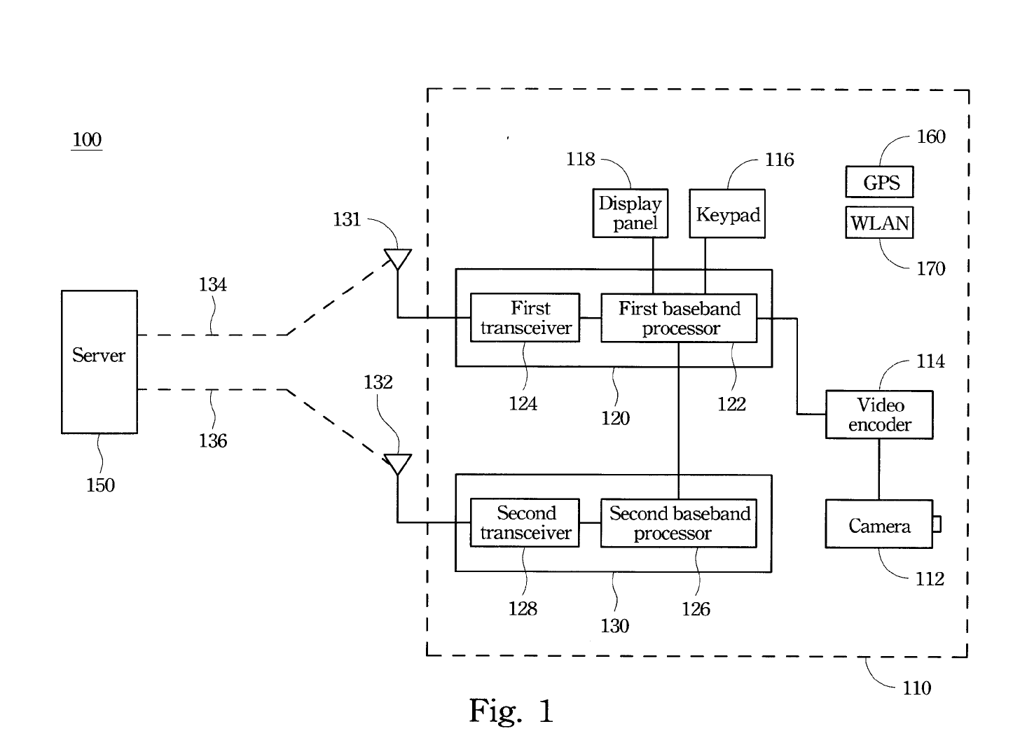

FIG. 1 is a diagram illustrating a system for video transmission using 3G mobile network according to one embodiment of this invention. A system 100 for video transmission using 3G mobile network includes a mobile video transmitter 110 and a server 150. The mobile video transmitter 110 that is capable of transmitting video packets via several uplink channels 134 and 136 of the 3G mobile network (e.g. 3G WCDMA/UMTS). The mobile video transmitter 110 includes a video encoder 114 and several transmitting devices 120 and 130. The video encoder 114 is capable of converting a video signal into the video packets.

The first transmitting device 120 contains a first transceiver 124 and a first baseband processor 122, and the second transmitting device 130 contains a second transceiver 126 and a second baseband processor 126. The first baseband processor 122 is connected to the video encoder 114, and the second baseband processor 126 is connected in series to the first baseband processor 122 to process a portion of the video packets for transmission. The first baseband processors 122 and the second baseband processor 126 are capable of processing and splitting the video packets. The first transceiver 124 having the first antenna 131 and the second transceiver 128 having the second antenna 132, are capable of transmitting the video packets. The first transceiver 124 and the second transceiver 128 may use different transmitting lo frequencies to transmit the video packets.

The video encoder 114 is capable of converting the video signal into the video packets based on amount of video packets waiting for transmission in the transceivers (e.g. the video packets waiting for transmission in the first transceiver 124 and the second transceiver 128) or the error rate of the video packets. According to one embodiment of the invention, the video encoder 114 may be implemented using a duplication of encoded video packets so that the critical information is duplicated for redundancy. The video encoder may employ H.264 encoding schemes for better video quality. Those skilled in the art know that the I-frame packet of the H.264 contains the basic frame of video signal at each major sampling interval whereas the P-frame contains the differential signal compared to the previous frame at each minor sampling interval. Hence, the I-frame packet is duplicated and transmitted respectively via transmitting devices 120 and 130. Thus, if one of the uplink channels 134 and 136 suffers from being assigned less bandwidth or encounters higher error rates, the aggregate received video at the server 150 will still have a good quality. By sending duplicated video packets via different uplink channels 134 and 136, the loss rate of I-frame packet will be significantly reduced. Due to the I-frame packet duplication, the total bandwidth needed for transmission may be increased. This may be solved by adjusting the I-frame packets delivery to a lower rate, for example, using one I-frame per 25 or 30 frames instead of one I-frame per 15 frames.

According to another embodiment of the invention, a method to improve video delivery quality is to dynamically adjust the frame rate and video encoding resolution based on the available bandwidth and channel error rate fed back from the first transceiver 124 and the second transceiver 128. When the queues in the first transmitting device 120 or the second transmitting device 122 becomes to full or heavily loaded, the video encoder 114 shall adjust the frame rate and resolution to fit in the available bandwidth of the uplink channels 131 and 132 to avoid buffer overflow and avoid the packet error rates from being too high to cause the issue of the video signal quality.

The mobile video transmitter 110 may further include an operating means, a display panel 118, a general positioning system (GPS) 160, a camera 112, memory storage (not shown), and a WLAN (WiFi) function 170. The operating means may be a keypad 116 or a touch screen (which may be integrated into the display panel 118), which is capable of keying the file name for the video signal, making note of the video signal and selecting destination for the video signal in the server. The display panel 118 is capable of displaying the operating means and the video signal. The GPS 160 enables the geographic location of the transmission or the location where the video signal is recorded. The WLAN function 170 may also provided such that when a WLAN is available that allows a higher uplink data rate to be implemented. The WLAN 170 of the mobile video transmission 110 may take advantage of the existing EAP-AKA or EAP-SIM methods to implement the WLAN authentication process. The memory storage is capable of storing the video packets such that the video packets may be transmitted at a later time (e.g. either by command from a user or when the device detects the availability of 3G network). The local memory may be a SD memory card and is interchangeable, in case the user may obtain the video packets directly by accessing the SD memory card and the user is located out of a 3G coverage area for an extended time.

The uplink channels 134 and 136 may be implemented using special linkage agreements with the mobile service provider so that the mobile video transmitter 110 has a higher priority to get simultaneous multiple uplink channels.

The server 150 receiving the video packets via the 3G mobile network is capable of sequencing and combining the video packets into the video signal.

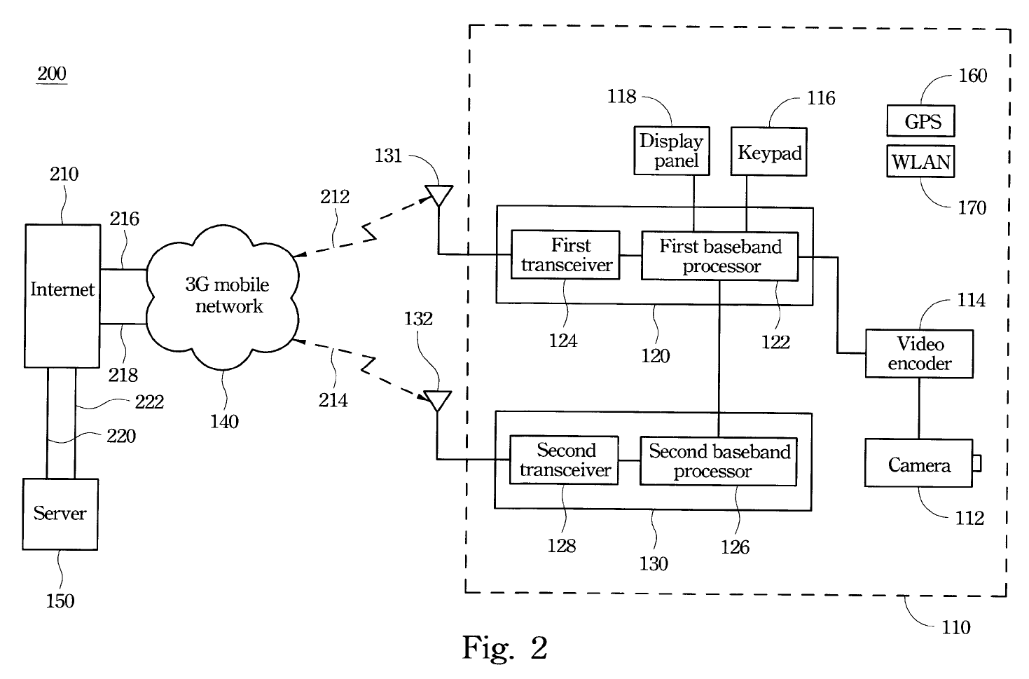

FIG. 2 is a diagram illustrating a system for video transmission using 3G mobile network according to another embodiment of this invention. A system 200 for video transmission using 3G mobile network includes a mobile video transmitter 110 and a server 150. The mobile video transmitter 110 is capable of transmitting video packets via several uplink channels 212 and 214 to 3G mobile network 140, and transmits respectively using path 216 and 218 to the Internet 210, and then respectively transmits the video packets to the server 150 via path 222 and 220. According to one embodiment of the invention, a multi-label switching method is implemented so that the transmission between the mobile video transmitter 110 and the server 150 is fixed, and the path 212, 214, 216, 218, 220, and 222 use special linkage agreements with the mobile service provider so that a virtual path is identified and fixed for the entire path from the mobile video transmitter 110 to the server 150. Further, the network routers/switches recognize the labeled video packets and give highest or higher priority in getting these packets through the routers/switches.

According to another embodiment of the invention, a UDP protocol is implemented to transmit the video packets between the mobile video transmitter and the server such that the video packets transmission does not require acknowledgements from the received server 150 and the delivery speed of uplink channel 134, 136, 212, 214 is not affected by the downlink traffic condition.

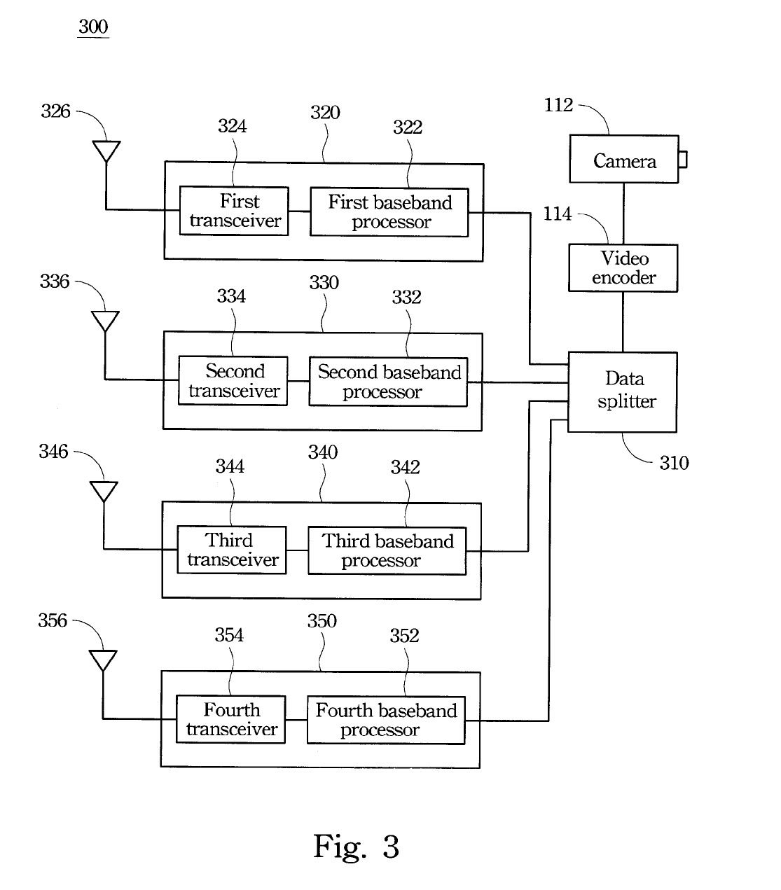

FIG. 3 is a diagram illustrating a mobile video transmitter 300 having 4 transceivers according to one embodiment of the invention. The mobile video transmitter 300 includes a data splitter 310, and several transmitting devices 320, 330, 340, and 350. The mobile video transmitter 300 is capable of transmitting several video packets via several uplink channels of 3G mobile network. The data splitter 310 is capable of splitting the video packets. The first transmitting devices 320, the second transmitting devices 330, the third transmitting devices 340, and the fourth transmitting devices 350 are coupled to the data splitter, and are capable of processing and transmitting the video packets. The first transmitting device 320 includes a first baseband processor 322 and a first transceiver 324, the second transmitting device 330 includes a second baseband processor 332 and a second transceiver 334, the third transmitting device 340 includes a third baseband processor 342 and a third transceiver 344, the fourth transmitting device 350 includes a fourth baseband processor 352 and a fourth transceiver 354.

According to one embodiment of the invention, the data splitter 310 assigns the video packets to the transmitting devices 320, 330, 340, and 350 using a water filling method such that the video packets waiting for transmission in each of the transmitting devices are equal. The mobile video transmitter 300 may includes a video encoder 114 and a camera 112 (as illustrated in FIG. 1 and FIG. 2). The first transceiver 324 having a first antenna 326, the second transceiver 334 having a second antenna 336, the third transceiver 344 having lo a third antenna 346, and the fourth transceiver 354 having a fourth antenna 356, are capable of transmitting the video packets.

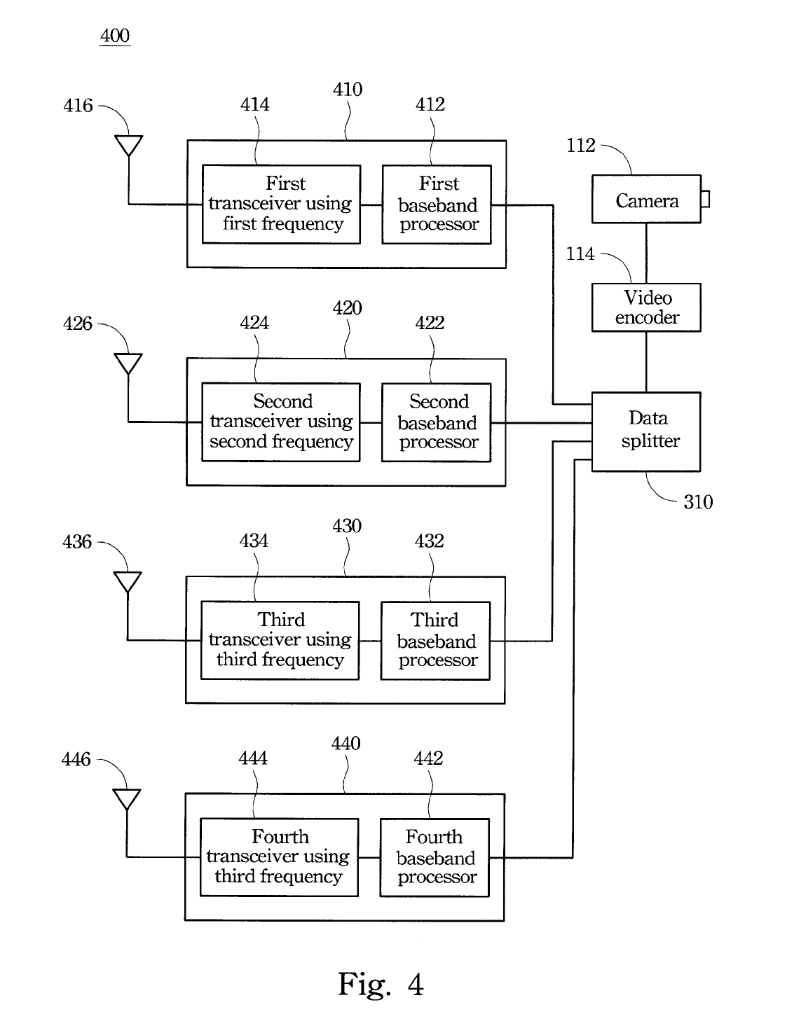

FIG. 4 is a diagram illustrating a mobile video transmitter having 4 transceivers and using 3 frequencies according to another embodiment of this invention. The mobile video transmitter 400 includes a data splitter 310, and several transmitting devices 410, 420, 430, and 440. The mobile video transmitter 400 is capable of transmitting several video packets via several uplink channels of 3G mobile network. The first transmitting device 410 includes a first baseband processor 412 and a first transceiver 414, the second transmitting device 420 includes a second baseband processor 422 and a second transceiver 424, the third transmitting device 430 includes a third baseband processor 432 and a third transceiver 434, the fourth transmitting device 440 includes a fourth baseband processor 442 and a fourth transceiver 444.

The first transceiver 414 having a first antenna 416 and is capable of transmitting the video packets using a first frequency, the second transceiver 424 having a second antenna 426 and is capable of transmitting the video packets using a second frequency, the third transceiver 434 having a third antenna 436 and is capable of transmitting the video packets using a third frequency, and the fourth transceiver 444 having a fourth antenna 446 and is capable of transmitting the video packets using the third frequency.

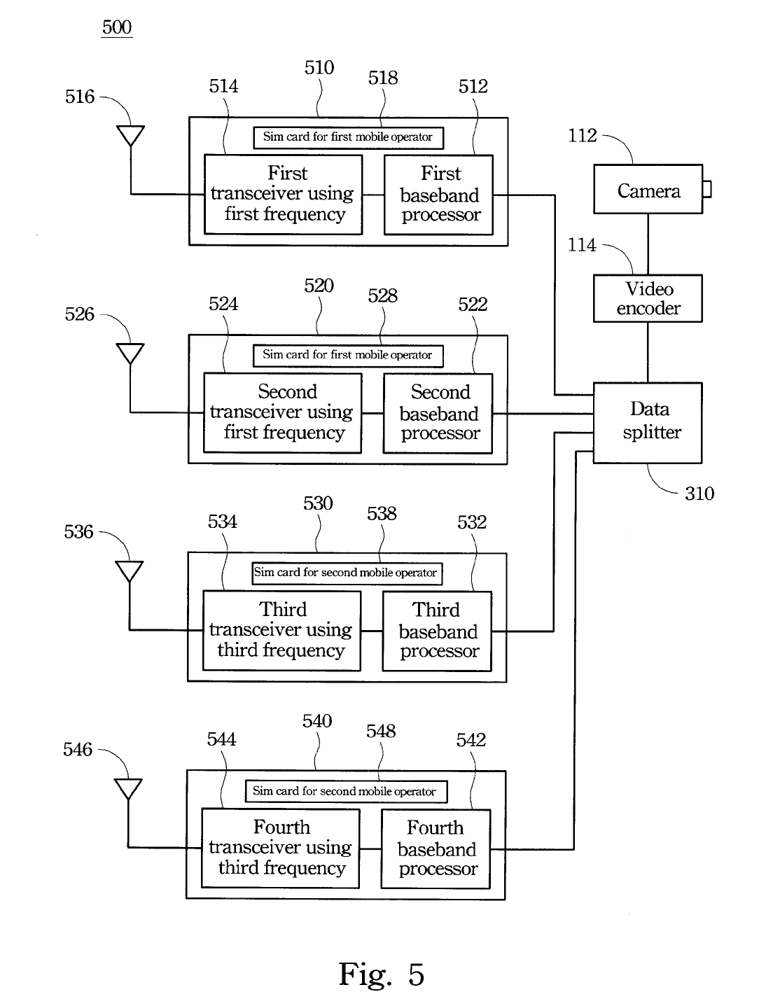

FIG. 5 is a diagram illustrating a mobile video transmitter using 2 mobile operators and having 2 frequencies according to another embodiment of this invention. The mobile video transmitter 500 includes a data splitter 310, and several transmitting devices 510, 520, 530, and 540. The mobile video lo transmitter 500 is capable of transmitting several video packets via several uplink channels by different 3G mobile networks.

The first transmitting device 510 includes a first baseband processor 512, a SIM card for first mobile operator 518, and a first transceiver 514. The second transmitting device 520 includes a second baseband processor 522, a SIM card for first mobile operator 528, and a second transceiver 524. The third transmitting device 530 includes a third baseband processor 532, a SIM card for second mobile operator 538, and a third transceiver 534. The fourth transmitting device 540 includes a fourth baseband processor 542, a SIM card for second mobile operator 548, and a fourth transceiver 544.

The first transceiver 514 having a first antenna 516 and capable of transmitting the video packets using a first frequency according to the SIM card for first mobile operator 518, the second transceiver 524 having a second antenna 526 and capable of transmitting the video packets using the first frequency according to the SIM card for first mobile operator 528, the third transceiver 534 having a third antenna 536 and is capable of transmitting the video packets using a third frequency according to the SIM card for second mobile operator 538, and the fourth transceiver 544 having a fourth antenna 546 and capable of transmitting the video packets using the third frequency according to the SIM card for second mobile operator 548.

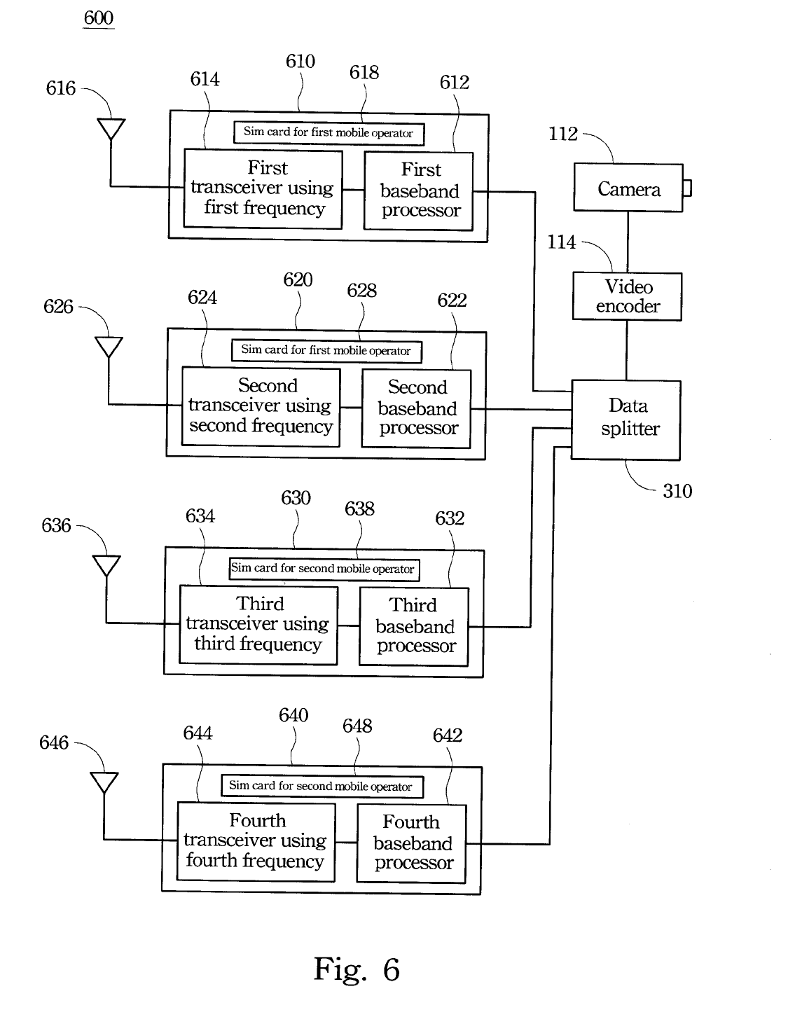

FIG. 6 is a diagram illustrating a mobile video transmitter using 2 mobile operators and having 4 frequencies according to another embodiment of this invention. The mobile video transmitter 600 includes a data splitter 310, and several transmitting devices 610, 620, 630, and 640. The mobile video lo transmitter 600 is capable of transmitting several video packets via several uplink channels by different 3G mobile networks.

The first transmitting device 610 includes a first baseband processor 612, a SIM card for first mobile operator 618, and a first transceiver 614. The second transmitting device 620 includes a second baseband processor 622, a SIM card for first mobile operator 628, and a second transceiver 624. The third transmitting device 630 includes a third baseband processor 632, a SIM card for second mobile operator 638, and a third transceiver 634. The fourth transmitting device 640 includes a fourth baseband processor 642, a SIM card for second mobile operator 648, and a fourth transceiver 644.

The first transceiver 614 having a first antenna 616 and capable of transmitting the video packets using a first frequency according to the SIM card for first mobile operator 618, the second transceiver 624 having a second antenna 626 and capable of transmitting the video packets using a second frequency according to the SIM card for first mobile operator 628, the third transceiver 634 having a third antenna 636 and capable of transmitting the video packets using a third frequency according to the SIM card for second mobile operator 638, and the fourth transceiver 644 having a fourth antenna 646 and capable of transmitting the video packets using a fourth frequency according to the SIM card for second mobile operator 648.

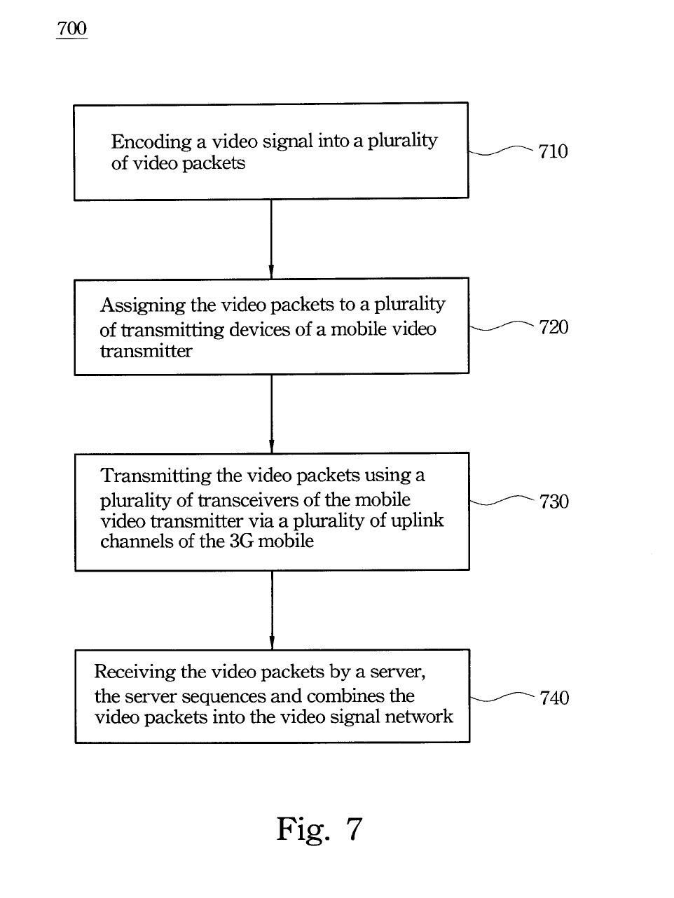

FIG. 7 is a flowchart illustrating a method 700 for video transmission using 3G mobile network according to one embodiment of this invention. The method 700 can be implemented using a transmitting device explained in FIG. 1 to FIG. 6. Step 710 encoding a video signal into a plurality of video packets. Step 720 assigning the video packets to several transmitting devices of a mobile video transmitter. Step 730 transmitting the video packets using several transceivers of the mobile video transmitter via several uplink channels of the 3G mobile network. Step 740 receiving the video packets by a server, the server sequencing and combining the video packets into the video signal.

According to one embodiment of the invention, encoding the video signal may be implemented using a gradual encoding method to encode the video signal into several resolutions. The gradual encoding method encodes the differences between a basic resolution and an original resolution of a video signal. For example, encoding the video signal using 3 different resolutions R1, R2, and R3, where R3 has higher resolution than R2, and R2 has higher resolution than R1. First, encode the R1 resulting in encoded S1. Then encode the difference between R1 and R2, resulting in encoded S2. Then further encode the difference between R2 and R3, resulting in encoded S2. When the transmission bandwidth shrinks or channel error rates are higher, S1 has higher priority than S2, and S2 has higher priority than S3 to transmit via the uplink channels of the 3G network.

According to one embodiment of the invention, a voice transmission may be implemented between the mobile video transmitter and a remote user. The voice communication uses one of the transceivers to connect the user of the mobile video transmitter with the remote director/conductor or a control center commander to guide the user how to react in the field scenes.

Although the present invention has been described in considerable detail with reference to certain preferred embodiments thereof, other embodiments are possible. For example, the mobile video transmitter may be added, removed, or replaced according to requirements (when higher transmission rate lo is required or when one of the transmitting devices is out of order). Therefore, their spirit and scope of the appended claims should not be limited to the description of the preferred embodiments contained herein.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

What is claimed is:

1. A system for video transmission using 3G mobile network, comprising:
a mobile video transmitter that is capable of transmitting a plurality of video packets via a plurality of uplink channels of the 3G mobile network, comprising:
a data splitter that is capable of splitting the video packets;
a plurality of transmitting devices coupled to the data splitter, each of the transmitting devices having a transceiver, the transmitting devices are capable of processing and transmitting the video packets;
wherein the data splitter assigns the video packets to the transmitting devices using a water filling method such that the video packets waiting for transmission in each of the transmitting devices are equal; and
a server receiving the video packets via the 3G mobile network, is capable of sequencing and combining the video packets into a video signal.

2. The system for video transmission using 3G mobile network of claim 1, wherein the mobile video transmitter further comprises an operating means and a display panel, the operating means is capable of keying a file name for the video signal, making note of the video signal and selecting destination for the video signal in the server, the display panel is capable of displaying the operating means and the video signal.

3. The system for video transmission using 3G mobile network of claim 1, wherein the mobile video transmitter further comprises a video encoder coupled to the data splitter, the video encoder is capable of converting the video signal into the video packets based on the amounts of the video packets waiting for transmission in the transceivers and error rate of the video packets.

4. The system for video transmission using 3G mobile network of claim 1, further comprises an internet system coupled to the 3G mobile network to receive the video packets, and transmit the video packets to the server.

5. The system for video transmission using 3G mobile network of claim 1, lo wherein the transceivers use different transmitting frequencies to transmit the video packets.

6. The system for video transmission using 3G mobile network of claim 1, wherein the mobile video transmitter further comprises a local storage means, the local storage means is capable of storing the video packets.

7. The system for video transmission using 3G mobile network of claim 1, wherein the mobile video transmitter further comprises a global positioning system so that the geographic location of the transmission is recorded or the location where the video signal is recorded.

8. A system for video transmission using 3G mobile network, comprising:
a mobile video transmitter that is capable of transmitting a plurality of video packets via a plurality of uplink channels of the 3G mobile network, comprising:
a video encoder, is capable of converting a video signal into the video packets;
a plurality of transmitting devices, each of the transmitting devices having a transceiver and a baseband processor, one of the baseband processors is connected to the video encoder, the baseband processors are capable of processing and splitting the video packets, and the transceivers are capable of transmitting the video packets;
wherein the baseband processors are connected in series to process a portion of the video packets for transmission, and the video encoder is capable of converting the video signal into the video packets based on amounts of the video packets waiting for transmission in the transceivers or error rate of the video packets; and
a server receiving the video packets via the 3G mobile network, is capable of sequencing and combining the video packets into the video.

9. The system for video transmission using 3G mobile network of claim 8, wherein the mobile video transmitter further comprises an operating means and a display panel, the operating means is capable of keying a file name for the video signal, making note of the video signal and selecting destination for the video signal in the server, the display panel is capable of displaying the operating means and the video signal.

10. The system for video transmission using 3G mobile network of claim 8, further comprises an internet system coupled to the 3G mobile network to receive the video packets, and transmits the video packets to the server.

11. The system for video transmission using 3G mobile network of claim 8, wherein the transceivers use different transmitting frequencies to transmit the video packets.

12. The system for video transmission using 3G mobile network of claim 8, wherein the mobile video transmitter further comprises a global positioning system so that the geographic location of the transmission is recorded or the location where the video signal is recorded.

13. The method for video transmission using 3G mobile network, comprising:
encoding a video signal into a plurality of video packets;
assigning the video packets to a plurality of transmitting devices of a mobile video transmitter;
transmitting the video packets using a plurality of transceivers of the mobile video transmitter via a plurality of uplink channels of the 3G mobile network; and
receiving the video packets by a server, the server sequences and combines the video packets into the video signal.

14. The method for video transmission using 3G mobile network of claim 13, wherein the server receiving the video packets from the 3G mobile network or an internet service.

15. The method for video transmission using 3G mobile network of claim 13, wherein in assigning the video packets it transmits the video packets in a series-connected transmitting devices such that each of the transmitting devices processes and transmits a portion of the video packets.

16. The method for video transmission using 3G mobile network of claim 13, wherein encoding the video signal into the video packets is according to the video packets waiting for transmission in the transceiver or the error rate of the video packets.

17. The method for video transmission using 3G mobile network of claim 13, wherein encoding the video signal into the video packets uses a duplication of encoded video packets so that the critical information is duplicated and transmitted via the different uplink channels.

18. The method for video transmission using 3G mobile network of claim 13, further comprises a multi-label switching method so that the transmission between the mobile video transmitter and the server is fixed.

19. The method for video transmission using 3G mobile network of claim 13, further comprises uses a UDP protocol to transmit the video packets between the mobile video transmitter and the server.

20. The method for video transmission using 3G mobile network of claim 13, further comprises a duplication method to duplicate the video packets containing critical information and assigns to the different transceivers.

21. The method for video transmission using 3G mobile network of claim 13, wherein encoding the video signal further comprises a gradual encoding method to encode the video signal into a plurality of different resolutions, and a basic resolution has a higher priority to transmit via the uplink channels.

22. The method for video transmission using 3G mobile network of claim 13, further comprises a voice transmission between the mobile video transmitter and a remote user.

23. The method for video transmission using 3G mobile network of claim 13, further comprises a GPS decoding function so that the video signal is recorded with the geographical location information or the geographic location of the transmission is recorded.

24. The method for video transmission using 3G mobile network of claim 13, wherein the transceivers of the transmitting device transmits the video packets using different frequencies via the uplink channels of the 3G mobile network.

25. The method for video transmission using 3G mobile network of claim 13, wherein the transceivers transmits the video packets using different 3G mobile networks.
